(19) United States
(12) Patent Application Publication
(10) Pub. No.: US 2026/0061564 A1
(43) Pub. Date: Mar. 5, 2026

(54) Motorized Clamp Device

(71) Applicant: Seth Reddick, Woodhull, IL (US)

(72) Inventor: Seth Reddick, Woodhull, IL (US)

(21) Appl. No.: 19/306,177

(22) Filed: Aug. 21, 2025

Related U.S. Application Data
(60) Provisional application No. 63/687,349, filed on Aug. 27, 2024.

(51) Int. Cl. B25B 5/10

(52) U.S. Cl. CPC B25B 5/101

(57) ABSTRACT

A motorized clamp device is provided. The device is comprised of an electric clamp configured to apply and release compressive force on a workpiece. The device comprises a high-torque electric motor operatively coupled to a motor controller, wherein the motor is configured to drive a mechanical assembly that translates rotational motion into linear displacement. The drive assembly connects the motor to a clamp arm that moves toward a fixed jaw to secure an object between the same. Power is provided by a battery and may be monitored through an integrated battery indicator. A control interface is provided for user interaction. The device further comprises a manual release mechanism allowing decoupling of the drive system for manual adjustments and emergency releases. A repositionable handle assembly with an adjustable pivot mechanism is included to optimize ergonomic usage.

### CROSS-REFERENCE TO RELATED APPLICATION

The present application claims priority to, and the benefit of, U.S. Provisional Application No. 63/687,349, which was filed on Aug. 27, 2024, and is incorporated herein by reference in its entirety.

### FIELD OF THE INVENTION

The present invention relates generally to the field of clamps. More specifically, the present invention relates to an electric clamp configured to apply and release compressive force on a workpiece using one hand or hands-free operation. Accordingly, the present disclosure makes specific reference thereto. Nonetheless, it is to be appreciated that aspects of the present invention are also equally applicable to other like applications, devices, and methods of manufacture.

### BACKGROUND

Traditional clamps require manual tightening, necessitating the use of both hands to secure workpieces. One hand must hold the clamp in position while the other applies the tightening force. This process complicates alignment and adjustment tasks, particularly when working with irregular objects or when precision is critical. The requirement for two-handed operation reduces overall efficiency and increases user fatigue during repetitive tasks. In many industrial, laboratory, and field environments, users often lack a third hand to assist in positioning or holding the clamp steady during actuation. Manual clamps are also subject to inconsistencies in applied force, potentially leading to damage to delicate materials or insufficient holding strength. As workpiece geometries and operational conditions vary, there is an increasing demand for a clamp that can deliver repeatable and adjustable force without compromising usability. The limitations of traditional clamps are especially pronounced in automated or remote applications, where manual intervention is not practical. As such, an improved solution that enables automated and hands-free operation is required to meet modern performance standards.

Therefore, there exists a long-felt need in the art for a motorized clamp device that allows for one-handed or hands-free operation during clamping procedures. There also exists a long-felt need in the art for a motorized clamp device that enables automated application and release of clamping force. Moreover, there exists a long-felt need in the art for a motorized clamp device that delivers consistent, adjustable force suitable for diverse workpiece types and operating environments.

The subject matter disclosed and claimed herein, in one embodiment thereof, comprises a motorized clamp device. The device is comprised of an electric clamp configured to apply and release compressive force on a workpiece. The device comprises a high-torque electric motor operatively coupled to a motor controller, wherein the motor is configured to drive a mechanical assembly that translates rotational motion into linear displacement. The drive assembly connects the motor to a clamp arm that moves toward a fixed jaw to secure an object between the same. Power is provided by a rechargeable battery that may be either integrated or removable via a compartment secured with a locking mechanism, and monitored through an integrated battery indicator. A control interface is provided for user interaction and may include tactile buttons or variable-speed actuation inputs. The device further comprises a manual release mechanism allowing decoupling of the drive system for manual adjustments and emergency releases. A repositionable handle assembly with an adjustable pivot mechanism is included to optimize ergonomic usage. In different embodiments, the device may be adapted to various clamp formats including but not limited to C-clamps, F-style clamps, and bar clamps, depending on application requirements.

In this manner, the motorized clamp device of the present invention accomplishes all the foregoing objectives and provides a clamp device that enables one-handed or hands-free clamping. The integration of an electric motor and motor controller with a mechanical drive assembly further enables consistent and repeatable clamping performance. The inclusion of a manual override, ergonomic handle, and modular gripping units further enhances usability and flexibility, while the rechargeable battery and control interface support efficient and uninterrupted operation. As a result, the motorized clamp device addresses the longstanding limitations of manual clamps and offers a practical, adaptable solution for both manual and automated applications.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized clamp device. The device is comprised of an electrically actuated clamp configured to apply and release clamping force, suitable for environments requiring adjustable, repeatable, and remotely controlled clamping operations such as automated manufacturing, laboratory applications, construction, and field services.

The device is comprised of a high-torque electric motor capable of delivering clamping force to accommodate workpieces of varying sizes, textures, and hardness. The electric motor may be of the brushed or brushless DC type and is coupled to a motor controller that modulates torque based on resistance feedback from a drive assembly or clamping resistance data.

The electric motor is operatively coupled to a drive assembly that converts rotational energy into linear motion to actuate a clamp arm. The clamp arm is configured to move linearly toward or away from a fixed jaw, generating an adjustable compressive force on a workpiece.

The power source of the device is a rechargeable battery comprised of high-energy-density chemistries such as lithium-ion, nickel-metal hydride, or lithium iron phosphate. The battery may be permanently integrated and charged via a compatible charging port. In an alternative configuration, the battery is a removable module housed within a compartment accessible through a secure door using mechanisms such as push-button latches or tamper-resistant fasteners.

A control interface enables user interaction for actuating and configuring the device. The device also includes a manual release button that activates a mechanical override to decouple the motor from the drive assembly, thus enabling manual clamp arm repositioning in emergency or precision alignment scenarios. A repositionable handle assembly is further included to facilitate ergonomic operation. The handle pivots between orientations through a locking pivot mechanism.

A method of use comprises providing the device with the described components, charging or installing the battery, positioning a workpiece between the clamp arm and fixed jaw, actuating the control interface to apply clamping force through the drive assembly, and modulating torque via the motor controller. Manual release is performed using the release button and mechanical override, and ergonomic adjustments are made by pivoting the handle to the desired orientation.

Accordingly, the motorized clamp device of the present invention is particularly advantageous as it provides a clamp device that enables one-handed or hands-free clamping. The integration of an electric motor and motor controller with a mechanical drive assembly further enables consistent and repeatable clamping performance. The inclusion of a manual override, ergonomic handle, and modular gripping units further enhances usability and flexibility, while the rechargeable battery and control interface support efficient and uninterrupted operation. As a result, the motorized clamp device addresses and overcomes the longstanding limitations of manual clamps known in the art and offers a practical, adaptable solution for both manual and automated applications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a motorized clamp device of the present invention in accordance with the disclosed architecture;

FIG. 2 illustrates a perspective view of one potential embodiment of a motorized clamp device of the present invention in accordance with the disclosed architecture;

FIG. 3 illustrates a side view of one potential embodiment of a motorized clamp device of the present invention in accordance with the disclosed architecture; and

FIG. 4 illustrates a flowchart of a method of using one potential embodiment of a motorized clamp device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a motorized clamp device that allows for one-handed or hands-free operation during clamping procedures. There also exists a long-felt need in the art for a motorized clamp device that enables automated application and release of clamping force. Moreover, there exists a long-felt need in the art for a motorized clamp device that delivers consistent, adjustable force suitable for diverse workpiece types and operating environments.

The present invention, in one exemplary embodiment, is comprised of a motorized clamp device. The device is an electrically actuated clamp designed to apply and release clamping force. This configuration supports adjustable, repeatable, and remotely controlled clamping operations, making the device well-suited for use in automated manufacturing, laboratory environments, construction, and field service applications.

A high-torque electric motor is integrated into the device to deliver sufficient clamping force for workpieces with varying dimensions, surface textures, and material hardness. The electric motor may be of the brushed or brushless DC type and is connected to a motor controller that adjusts torque delivery based on resistance feedback from a drive assembly or clamping resistance data. The electric motor is mechanically linked to a drive assembly that transforms rotational motion into linear displacement, thereby actuating a clamp arm. The clamp arm moves linearly toward or away from a fixed jaw to generate an adjustable compressive force on the workpiece.

Power is supplied by a rechargeable battery comprised of high-energy-density chemistries, including lithium-ion, nickel-metal hydride, or lithium iron phosphate. The battery may be either permanently embedded in the device and charged through a compatible charging port or configured as a removable module placed within a compartment secured by mechanisms such as push-button latches or tamper-resistant fasteners.

User interaction is enabled through a control interface, which allows for actuation and configuration of the device. Additionally, the device includes a manual release button that triggers a mechanical override to disengage the motor from the drive assembly, facilitating manual repositioning of the clamp arm during emergencies or fine alignment tasks. For enhanced ergonomics, a repositionable handle assembly is incorporated and can pivot between orientations using a locking pivot mechanism.

A method of use includes preparing the device with the specified components, charging or inserting the battery, positioning a workpiece between the clamp arm and fixed jaw, and actuating the control interface to apply clamping force via the drive assembly. Torque is regulated by the motor controller. Manual release is performed using the release button and mechanical override, while ergonomic adjustments are achieved by rotating the handle to a suitable orientation.

As a result, the motorized clamp device offers a significant improvement by enabling hands-free or single-handed clamping. The integration of an electric motor, motor controller, and drive assembly ensures consistent and repeatable performance. Additional features, including a manual override and an ergonomic handle contribute to enhanced usability and versatility. The inclusion of a rechargeable battery and user interface further promotes efficient, uninterrupted operation, addressing limitations inherent in conventional manual clamps and providing a practical, adaptable solution for both manual and automated use cases.

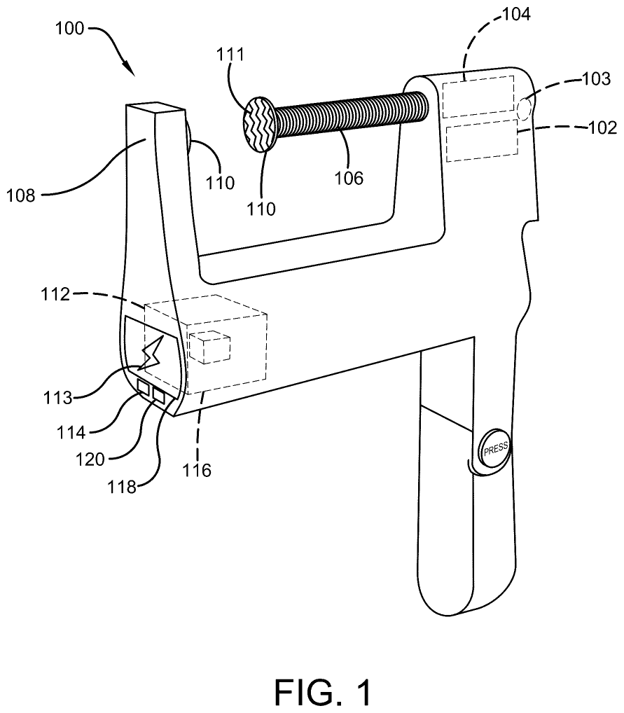

Referring initially to the drawings, FIG. 1 illustrates a perspective view of one potential embodiment of a motorized clamp device 100 of the present invention in accordance with the disclosed architecture. The device 100 may be comprised of an electrically actuated clamp configured to apply and release clamping force. As such, the device 100 is suitable for use in automated manufacturing systems, laboratory environments, construction tasks, and field service operations where adjustable, repeatable, and remotely controllable clamping is beneficial.

The device 100 is comprised of a high-torque electric motor 102. The electric motor 102 may be capable of generating sufficient torque to exert clamping forces suitable for a broad range of workpieces with differing dimensions, surface textures, and material hardness. The motor 102 may be of a brushed or brushless DC type. The motor 102 may be coupled to a motor controller 103 which may modulate torque delivery based on resistance feedback from a drive assembly 104 or clamping resistance data.

The motor 102 may be operatively coupled to the drive assembly 104, as seen in FIG. 1. The drive assembly 104 may translate rotational energy into linear motion required to actuate a clamp arm 106. The drive assembly 104 may be configured in various forms such as but not limited to a multi-stage planetary gear system, a lead screw with anti-backlash nut, a ball screw with preload compensation, a rack and pinion system with self-lubricating bushings, a harmonic drive for compact high-torque transmission, etc.

The clamp arm 106 may be configured to move linearly toward or away from a fixed jaw 108, generating an adjustable compressive force on a workpiece between the same. The clamp arm 106 and fixed jaw 108 may be fabricated from high-strength materials such as but not limited to hardened steel, anodized aluminum, carbon fiber-reinforced polymer, titanium alloy, etc. The gripping units 110 of both the clamp arm 106 and the fixed jaw 108 may be configured for optimal engagement with various surfaces. More specifically, said gripping units 110 may be modular or replaceable, and may be made from a non-slip material such as but not limited to thermoplastic elastomer. The units 110 may further include textures 111 such as but not limited to diamond-patterned knurling, V-grooves for cylindrical workpieces, PTFE, ceramic grit, polyurethane, etc. to minimize marring or slippage.

The power source for the device 100 may be a rechargeable battery 112, as seen in FIG. 1. The battery 112 may be comprised of lithium-ion, nickel-metal hydride, lithium iron phosphate, or other high-energy-density rechargeable chemistries. In one embodiment, the battery 112 may be permanently integrated within the device 100 and charged via a compatible charging port 114 such as but not limited to a USB-C connector, a magnetic pogo-pin interface, an inductive wireless charging coil, etc.

In another embodiment, the battery 112 may be configured as a removable module housed within a battery compartment 116. The compartment 116 may be accessible through a door 118 such as but not limited to a flip-down door, sliding latch panel, hinged cover with spring assist, or quick-release locking flap. The door 118 may be secured by a locking mechanism 120 such as but not limited to a push-button latch, sliding tab lock, rotary knob lock, or tamper-resistant fastener. In one embodiment, the device is comprised of a battery indicator 113 such as but not limited to an LED or an electronic display screen that integrates the amount of power the battery 112 has remaining.

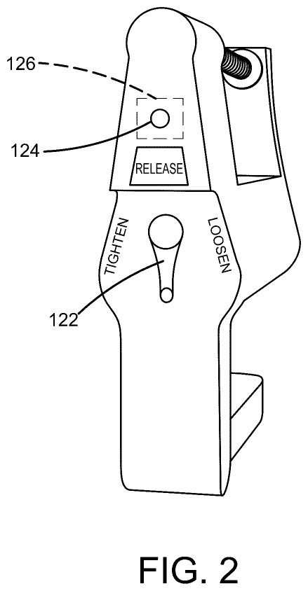

A control interface 122 may allow user interaction for actuation and configuration of the device 100, as seen in FIG. 2. The control interface 122 may be in the form of (but not limited to) a rocker switch designed for thumb operation, with configurations such as momentary-action, dual-position lock, and/or proportional pressure sensitivity for variable-speed actuation. Alternative control interfaces 122 may include but not be limited to tactile pushbuttons, capacitive touch panels, rotary dials, etc.

In addition to powered operation, the device 100 may be comprised of a manual release button 124. The manual release button 124 may decouple the motor 102 from the drive assembly 104 using a mechanical override 126. The mechanical override 126 may be configured as a spring-loaded clutch, cam lever, over-center toggle, pawl and ratchet disengagement system, or ball-detent mechanism. This manual feature may enable immediate retraction or repositioning of the clamp arm 106 without engaging the electric motor 102, particularly useful in emergency situations, battery depletion, or fine manual alignment tasks.

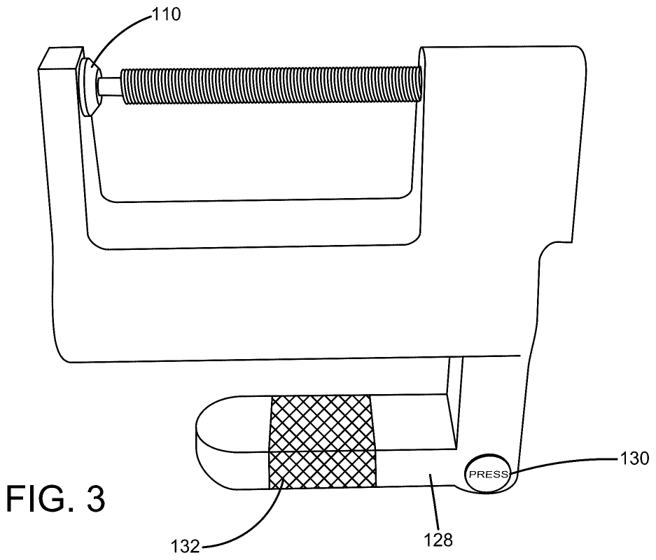

A repositionable handle assembly 128 may be incorporated into the device 100 to facilitate ergonomic operation. In one embodiment, the handle 128 may be pivotable between horizontal (as seen in FIG. 3) and vertical orientations (as seen in FIG. 1) through a button-activated pivot mechanism 130. Alternative locking pivoting mechanism 130 may include but not be limited to detent plates with indexing holes, spring-loaded ball plungers, ratcheting splines, or friction-locking hinges. The handle assembly 128 may rotate between 0 and 180 degrees or more, depending on design constraints. The grip area 132 of the handle 128 may be comprised of materials that promote operator comfort and control, such as but not limited to overmolded rubber, silicone-coated thermoplastic, textured polymer, grip-enhancing foams, etc. In another embodiment, the handle assembly 128 is not repositionable.

While one embodiment describes the device 100 in the form of a motorized C-clamp, alternate configurations may include but are not limited to F-style clamps, bar clamps, pipe clamps, spring clamps, toggle clamps, parallel-jaw clamps, corner clamps, or quick-release trigger clamps. In such configurations, the motor 102, drive assembly 104, control interface 122, and associated clamping components may be adapted and scaled to suit the specific structural requirements and operating conditions of the corresponding clamp style.

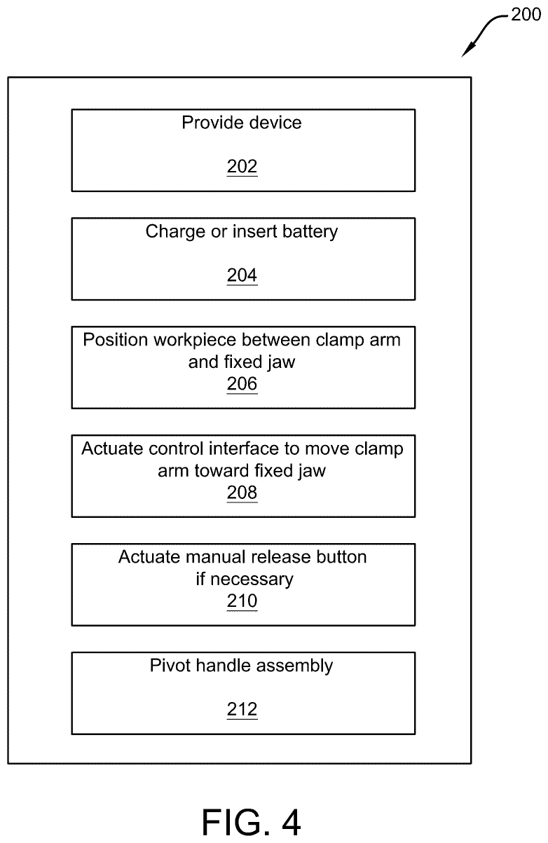

The present invention is also comprised of a method of using 200 the device 100, as seen in FIG. 4. First, a device 100 is provided comprised of a high-torque electric motor 102 operatively coupled to a motor controller 103, a drive assembly 104, a clamp arm 106, a fixed jaw 108, modular gripping units 110, a rechargeable battery 112, a charging port 114, a battery compartment 116 with a door 118 and locking mechanism 120, a battery indicator 113, a control interface 122, a manual release button 124, a mechanical override 126, and a repositionable handle assembly 128 with a pivot mechanism 130 and grip area 132 [Step 202]. Then, the battery 112 is either charged via the charging port 114 or inserted into the battery compartment 116 through the door 118, which is then secured using the locking mechanism 120 [Step 204]. Next, a workpiece is positioned between the clamp arm 106 and the fixed jaw 108 such that the gripping units 110 engage the workpiece surface [Step 206]. Then, the control interface 122 is actuated by the user to engage the motor 102, which transmits torque through the drive assembly 104, resulting in linear movement of the clamp arm 106 toward the fixed jaw 108 to apply clamping force on the workpiece [Step 208]. The motor controller 103 then modulates torque output based on resistance feedback from the drive assembly 104 or clamping resistance data to ensure appropriate force is applied based on the workpiece characteristics. In the event manual repositioning or release of the clamp arm 106 is required, the manual release button 124 is actuated to decouple the motor 102 from the drive assembly 104 via the mechanical override 126 [Step 210]. At any time, the handle assembly 128 may be pivoted to a desired ergonomic orientation using the pivot mechanism 130 to enhance operational comfort and control [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorized clamp device” and “device” are interchangeable and refer to the motorized clamp device 100 of the present invention.

Notwithstanding the forgoing, the motorized clamp device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the motorized clamp device 100 as shown in the FIGS. are for illustrative purposes only, and that many other sizes and shapes of the motorized clamp device 100 are well within the scope of the present disclosure. Although the dimensions of the motorized clamp device 100 are important design parameters for user convenience, the motorized clamp device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized clamp device comprising:
an electric motor;
a drive assembly operatively coupled to the electric motor and configured to convert rotational energy into linear motion;
a clamp arm operatively coupled to the drive assembly;
a fixed jaw positioned opposite of the clamp arm;
a battery;
a handle; and
a control interface.

2. The motorized clamp device of claim 1, wherein the drive assembly is comprised of a multi-stage planetary gear system.

3. The motorized clamp device of claim 1, wherein the fixed jaw is comprised of a first gripping unit.

4. The motorized clamp device of claim 3, wherein the first gripping unit is comprised of a first texture.

5. The motorized clamp device of claim 1, wherein the clamp arm is comprised of a second gripping unit.

6. The motorized clamp device of claim 3, wherein the second gripping unit is comprised of a second texture.

7. The motorized clamp device of claim 1 further comprised of a charging port.

8. The motorized clamp device of claim 1, wherein the control interface is comprised of a button.

9. The motorized clamp device of claim 1 further comprised of a manual release button.

10. The motorized clamp device of claim 9 further comprised of a mechanical override that decouples the motor from the drive assembly.

11. A motorized clamp device comprising:
an electric motor;
a motor controller;
a drive assembly operatively coupled to the electric motor and configured to convert rotational energy into linear motion;
a clamp arm operatively coupled to the drive assembly;
a fixed jaw positioned opposite of the clamp arm;
a battery;
a repositionable handle;
a battery indicator; and
a control interface.

12. The motorized clamp device of claim 11, wherein the motor controller modulates a torque of the motor.

13. The motorized clamp device of claim 11, wherein the handle attaches to a pivot point.

14. The motorized clamp device of claim 11, wherein the handle is comprised of a grip area comprised of a texture.

15. The motorized clamp device of claim 11 further comprised of a battery compartment.

16. The motorized clamp device of claim 15 further comprised of a battery door.

17. The motorized clamp device of claim 15 further comprised of a locking mechanism.

18. The motorized clamp device of claim 11, wherein the control interface is comprised of a rocker switch.

19. The motorized clamp device of claim 13, wherein the handle is pivotable around the pivot point from a first position to a second position.

20. A method of using a motorized clamp device, the method comprising the following steps:
providing a motorized clamp device comprised of an electric motor, a drive assembly, a clamp arm, a fixed jaw, a battery, a control interface, a pivot point, and a handle;
positioning a workpiece between the clamp arm and the fixed jaw; and
actuating the control interface to engage the electric motor to move the clamp arm linearly toward the fixed jaw.
